(19) United States
(12) Patent Application Publication
(10) Pub. No.: US 2024/0277550 A1
(43) Pub. Date: Aug. 22, 2024

(54) METHOD AND DEVICE FOR CONTROLLING WEARABLE DEVICE ON BASIS OF USER’S HEART RATE

(71) Applicant: Samsung Electronics Co., Ltd., Suwon-si (KR)

(72) Inventors: Dongwoo KIM, Suwon-si (KR); Jaehun HYEON, Suwon-si (KR); Sungwan KOO, Suwon-si (KR); Kiwan LEE, Suwon-si (KR); Hwangjae LEE, Suwon-si (KR); Kyongtae KIM, Suwon-si (KR); Sungcheol KIM, Suwon-si (KR); Geogeun PARK, Suwon-si (KR); Jiyoon PARK, Suwon-si (KR)

(21) Appl. No.: 18/649,378

(22) Filed: Apr. 29, 2024

Related U.S. Application Data
(63) Continuation of application No. PCT/KR2022/013311, filed on Sep. 6, 2022.

(30) Foreign Application Priority Data
Nov. 4, 2021 (KR) 10-2021-0150250
Jul. 27, 2022 (KR) 10-2022-0093219

(51) Int. Cl. A61H 3/00; A61H 1/02

(52) U.S. Cl. CPC A61H 3/00; A61H 1/0244; A61H 2201/0157; A61H 2201/1215; A61H 2201/163; A61H 2201/1642; A61H 2201/165; A61H 2201/5007; A61H 2201/5069; A61H 2201/5097; A61H 2230/065; A61H 2230/208

(57) ABSTRACT

An electronic device may: set a target heart rate for a user wearing a wearable device (e.g., walking assist device); receive information of the user's current heart rate; determine, on the basis of the current heart rate and the target heart rate, target exercise load such that the user's heart rate can correspond to the target heart rate; and control the wearable device such that the target exercise load is provided to the user. Various other embodiments may also be possible.

### CROSS-REFERENCE TO RELATED APPLICATIONS

This application is a continuation application of International Application No. PCT/KR2022/013311 designating the United States, filed on Sep. 6, 2022, in the Korean Intellectual Property Receiving Office and claiming priority to Korean Patent Application No. 10-2021-0150250, filed on Nov. 4, 2021 and Korean Patent Application No. 10-2022-0093219, filed on Jul. 27, 2022, in the Korean Intellectual Property Office, the disclosures of which are all hereby incorporated by reference herein in their entireties.

### BACKGROUND

### 1. Field

Certain example embodiments relate to technology for controlling a wearable device to be worn on a user, based on heart rate of the user.

### 2. Description of Related Art

A change into aging societies has contributed to a growing number of people who experience inconvenience and pain from reduced muscular strength or joint problems due to aging. Thus, there is a growing interest in walking assist devices that enable elderly users or patients with reduced muscular strength or joint problems to walk with less effort, and/or to assist those desirable with respect to exercise.

### SUMMARY

According to an example embodiment, an electronic device may include a communication module, comprising communication circuitry, configured to exchange data with an external device, at least one processor, comprising processing circuitry, and memory storing instructions that when executed by the at least one processor individually and/or collectively, cause the electronic device to at least: set a target heart rate of a user wearing a wearable device, receive information about a current heart rate of the user, determine a target magnitude of a workout load so that a heart rate of the user corresponds to the target heart rate based on the current heart rate and the target heart rate, and control the wearable device so that the target magnitude of the workout load is provided to the user. The electronic device may optionally be part of the wearable device.

According to an example embodiment, a method performed by an electronic device may include setting a target heart rate of a user wearing a wearable device, receiving information about a current heart rate of the user, determining a target magnitude of a workout load so that a heart rate of the user corresponds to the target heart rate based on the current heart rate and the target heart rate, and controlling the wearable device so that the target magnitude of the workout load is provided to the user.

### BRIEF DESCRIPTION OF DRAWINGS

The above and other aspects, features, and advantages of certain example embodiments will be more apparent from the following detailed description, taken in conjunction with the accompanying drawings, in which:

FIG. 1 is a diagram illustrating a configuration of a system for providing a user with a workout program according to an example embodiment,

FIG. 2 is a block diagram of an electronic device in a network environment according to an example embodiment,

FIGS. 3A to 3D are diagrams illustrating a wearable device according to an example embodiment,

FIG. 4 is a diagram illustrating a wearable device communicating with an electronic device according to an example embodiment,

FIGS. 5 and 6 are diagrams illustrating a torque output method of a wearable device according to an example embodiment,

FIG. 7 illustrates areas of workout intensity according to user's ages and workout purposes according to an example embodiment,

FIG. 8 is a flowchart illustrating a method of controlling a wearable device based on a heart rate of a user according to an example embodiment,

FIG. 9 is a flowchart of a method of determining a target magnitude of a workout load based on a current heart rate and a target heart rate according to an example embodiment,

FIG. 10 is a flowchart illustrating a method of changing a target heart rate according to an example embodiment,

FIG. 11 illustrates a change in target heart rate, an altitude change, and a magnitude change of a workout load to be output in a workout program including a plurality of workout sections according to an example embodiment,

FIG. 12 is a flowchart illustrating a method of changing a target heart rate based on saturation of partial pressure oxygen of a user according to an example embodiment,

FIG. 13 is a flowchart illustrating a method of changing a target heart rate based on workout information of a user according to an example embodiment,

FIG. 14 is a diagram illustrating a configuration of a server according to an example embodiment.

### DETAILED DESCRIPTION

Hereinafter, various embodiments of the present disclosure will be described with reference to the accompanying drawings. However, this is not intended to limit the present disclosure to specific embodiments, and it should be understood that various modifications, equivalents, and/or alternatives of the embodiments of the present disclosure are included.

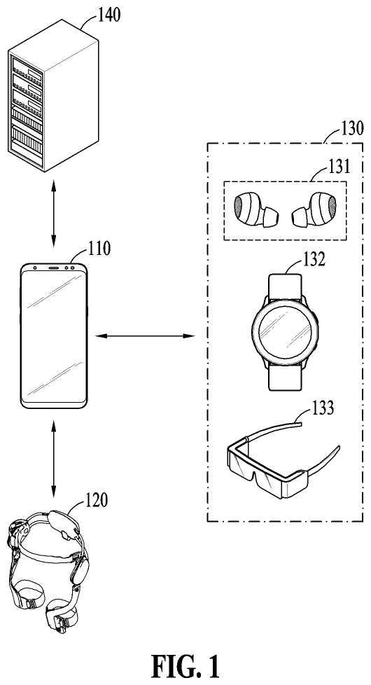

FIG. 1 is a diagram illustrating a configuration of a system for providing a user with a workout program according to an embodiment.

According to an embodiment, a system 100 for providing a user with a workout program may include an electronic device 110, a wearable device 120, an additional device 130, and a server 140.

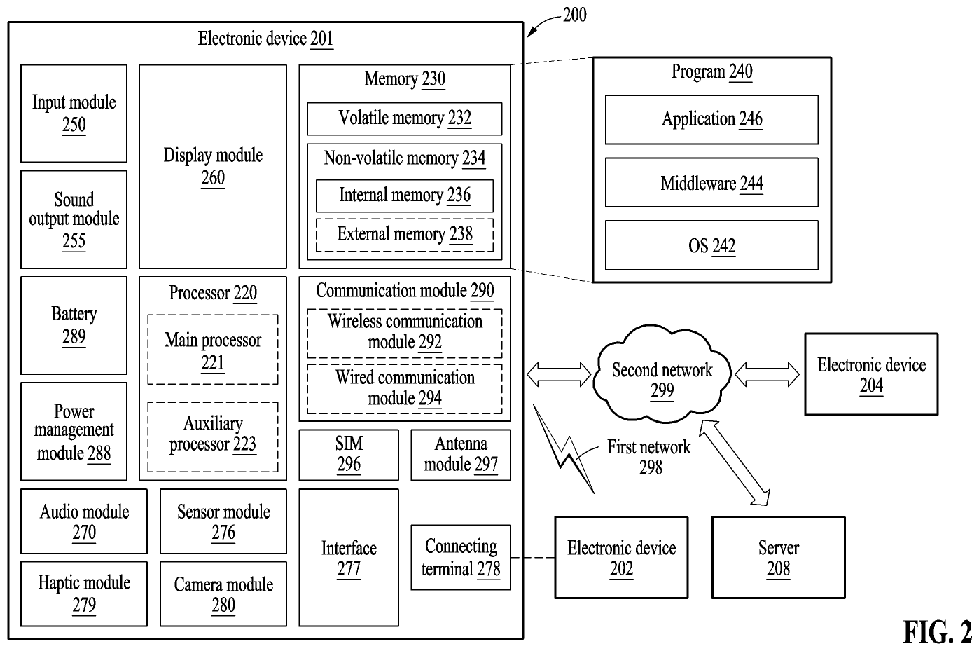

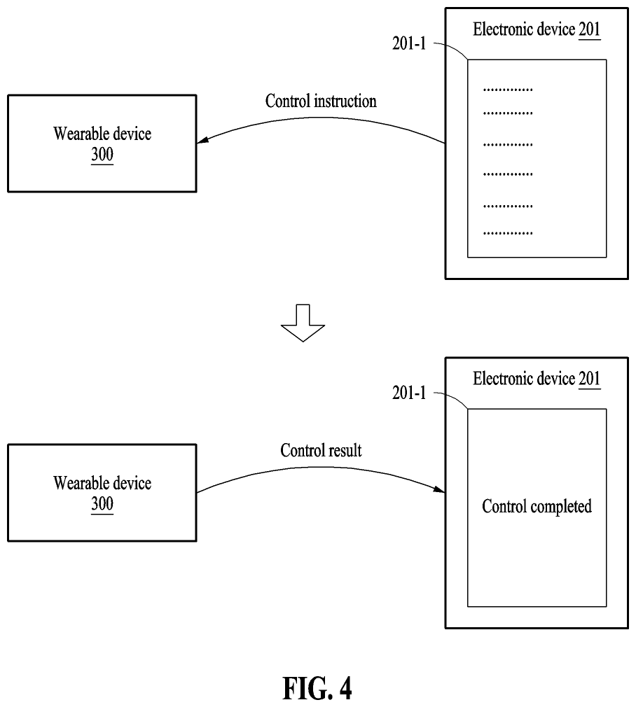

According to an embodiment, the electronic device 110 may be a user terminal that may be connected, directly or indirectly, to the wearable device 120 using short-range wireless communication. For example, the electronic device 110 may transmit a control signal for controlling the wearable device 120 to the wearable device 120. The electronic device 110 will be described in detail below with reference to FIG. 2, and the transmission of a control signal will be described in detail below with reference to FIG. 4.

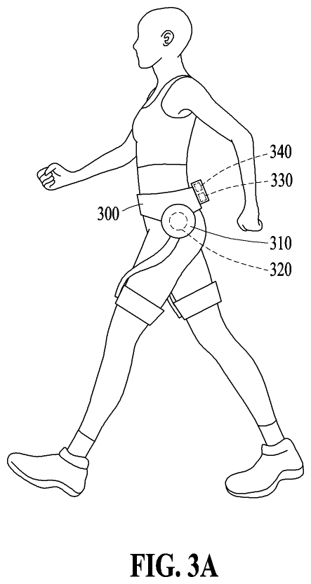

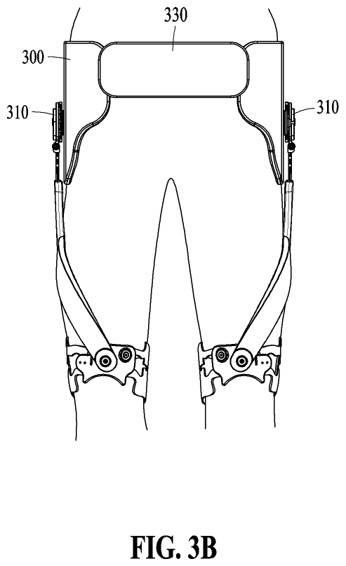

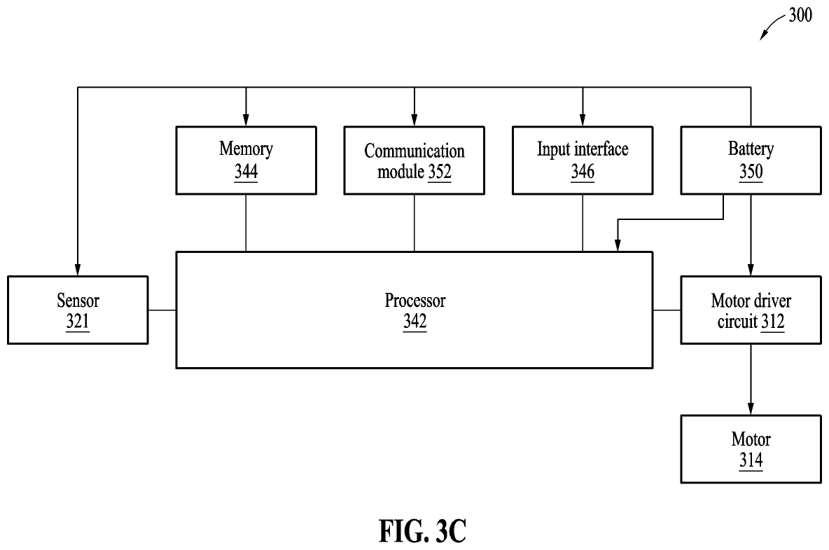

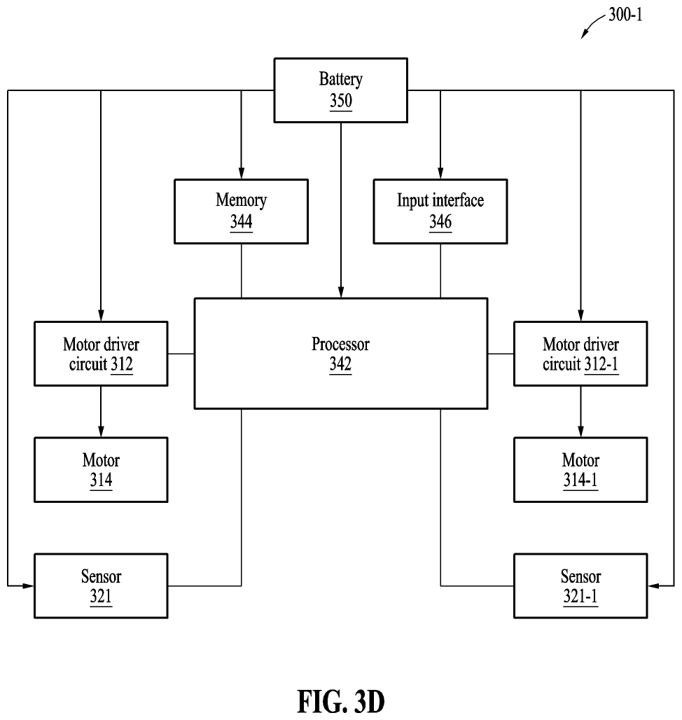

According to an embodiment, the wearable device 120 may provide a user wearing the wearable device 120 with an assistance force for assisting a gait or a resistance force for impeding a gait. The resistance force may be provided to the user to assist the user in doing a workout. The values of various control parameters used in the wearable device 120 may be controlled to control the assistance force or the resistance force output by the wearable device 120. The structure and driving method of the wearable device 120 will be described in detail below with reference to FIGS. 3A to 7.

According to an embodiment, the electronic device 110 may be connected, directly or indirectly, to the additional device 130 (e.g., wireless earphones 131, a smart watch 132, or smart glasses 133) using short-range wireless communication. For example, the electronic device 110 may output information indicating the state of the electronic device 110 or the state of the wearable device 120 to the user through the additional device 130. For example, feedback information with respect to a walking state of the user wearing the wearable device 120 may be output through a haptic device, a speaker device, and a display device of the additional device 130.

According to an embodiment, the electronic device 110 may be connected to the server 140 using short-range wireless communication or cellular communication. For example, the server 140 may include a database in which information about a plurality of workout programs to be provided to a user through the wearable device 120 is stored. For example, the server 140 may manage a user account of the user of the electronic device 110 or the wearable device 120. The server 140 may store and manage a workout program performed by the user and a result of performance with respect to the workout program in link with the user account. An example of the configuration of the server 140 will be described in detail below with reference to FIG. 14.

According to an embodiment, the system 100 may provide the user with a workout program for achieving a workout goal in various workout environments desired by the user. For example, the workout goal of the user may be set in advance, and may include, for example, improved walking ability, improved walking pose, improved cardiovascular health, and improved muscle fitness. Under these exercise goals, the user may designate a specific workout environment each time the user does a workout. For example, the user may designate a target workout section and a target workout time as a workout environment through the electronic device 110 before doing a workout. The electronic device 110 may determine the values of the control parameters of the wearable device 120 that may satisfy the workout environment in consideration of the set workout goals. For example, the control parameters may include parameters for adjusting at least one of a magnitude of a torque to be output through the wearable device 120, a direction of the torque, a timing of the torque, an offset angle between joint angles of the wearable device 120, or a sensitivity of a state factor with respect to the joint angles. The electronic device 110 may obtain one or more workout programs based on the determined values of the control parameters.

According to an embodiment, the workout program may be related to a method of providing the assistance force or the resistance force provided to the user wearing the wearable device 120 in the set workout environment. For example, the workout program may provide the user with the same assistance force or resistance force during the entire workout time. In another example, the workout program may divide the entire workout time into a plurality of sections, and provide the user with different assistance forces or resistance forces in the plurality of sections. For example, an output timing of the assistance force or the resistance force output through the workout program may vary depending on the target workout time and the workout goals.

According to an embodiment, the plurality of workout programs may be stored in the electronic device 110 or in the server 140 as a database. For example, the electronic device 110 or the server 140 may recommend one or more of the plurality of workout programs to the user based on the determined values of the control parameters. For example, the electronic device 110 or the server 140 may determine a workout program to be recommended to the user based on a workout history of the user. Accordingly, the user may be recommended for a new workout program even when the user does a workout in the same workout environment, and the user may feel that the user is doing a workout different from the previous workout by performing the new workout program.

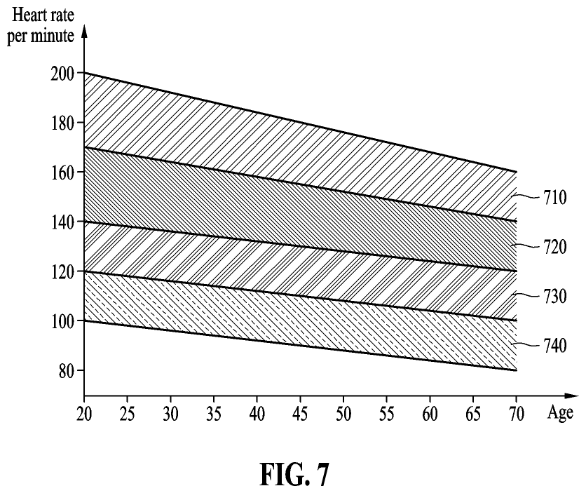

According to an embodiment, the electronic device 110 may receive information about a current heart rate of the user during the performance of the workout of the user wearing the wearable device 120, and control the wearable device 120 based on the current heart rate of the user. For example, the electronic device 110 may control the wearable device 120 to adjust the assistance force or the resistance force output to the user by the wearable device 120. A method of controlling the wearable device 120 based on the heart rate of the user will be described in detail below with reference to FIGS. 7 to 13.

FIG. 2 is a block diagram of an electronic device in a network environment according to an embodiment.

FIG. 2 is a block diagram of an electronic device 201 (e.g., the electronic device 110 of FIG. 1) in a network environment 200 according to an embodiment. Referring to FIG. 2, the electronic device 201 in the network environment 200 may communicate with an electronic device 202 via a first network 298 (e.g., a short-range wireless communication network), or communicate with at least one of an electronic device 204 or a server 208 via a second network 299 (e.g., a long-range wireless communication network). According to an embodiment, the electronic device 201 may communicate with the electronic device 204 via the server 208. According to an embodiment, the electronic device 201 may include a processor 220, a memory 230, an input module 250, a sound output module 255, a display module 260, an audio module 270, a sensor module 276, an interface 277, a connecting terminal 278, a haptic module 279, a camera module 280, a power management module 288, a battery 289, a communication module 290, a subscriber identification module (SIM) 296, or an antenna module 297. In some embodiments, at least one (e.g., the connecting terminal 278) of the above components may be omitted from the electronic device 201, or one or more other components may be added in the electronic device 201. In some embodiments, some (e.g., the sensor module 276, the camera module 280, or the antenna module 297) of the components may be integrated as a single component (e.g., the display module 260).

The processor 220 may execute, for example, software (e.g., a program 240) to control at least one other component (e.g., a hardware or software component) of the electronic device 201 connected, directly or indirectly, to the processor 220, and may perform various data processing or computation. According to an embodiment, as at least a portion of data processing or computation, the processor 220 may store a command or data received from another component (e.g., the sensor module 276 or the communication module 290) in a volatile memory 232, process the command or the data stored in the volatile memory 232, and store resulting data in a non-volatile memory 234. According to an embodiment, the processor 220 may include a main processor 221 (e.g., a central processing unit (CPU) or an application processor (AP)) or an auxiliary processor 223 (e.g., a graphics processing unit (GPU), a neural processing unit (NPU), an image signal processor (ISP), a sensor hub processor, or a communication processor (CP)) that is operable independently of, or in conjunction with the main processor 221. For example, when the electronic device 201 may include the main processor 221 and the auxiliary processor 223, the auxiliary processor 223 may be adapted to consume less power than the main processor 221 or to be specific to a specified function. The auxiliary processor 223 may be implemented separately from the main processor 221 or as a portion of the main processor 221.

The auxiliary processor 223 may control at least some of functions or states related to at least one (e.g., the display module 260, the sensor module 276, or the communication module 290) of the components of the electronic device 201, instead of the main processor 221 while the main processor 221 is in an inactive (e.g., sleep) state, or together with the main processor 221 while the main processor 221 is in an active state (e.g., executing an application). According to an embodiment, the auxiliary processor 223 (e.g., an ISP or a CP) may be implemented as a portion of another component (e.g., the camera module 280 or the communication module 290) that is functionally related to the auxiliary processor 223. According to an embodiment, the auxiliary processor 223 (e.g., an NPU) may include a hardware structure specified for artificial intelligence (AI) model processing. An AI model may be generated by machine learning. Such learning may be performed, for example, by the electronic device 201 in which an AI mode is executed, or via a separate server (e.g., the server 208). Learning algorithms may include, but are not limited to, for example, supervised learning, unsupervised learning, semi-supervised learning, or reinforcement learning. The AI model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), and a bidirectional recurrent deep neural network (BRDNN), a deep Q-network, or a combination of two or more thereof, but is not limited thereto. The AI model may additionally or alternatively include a software structure other than the hardware structure.

The memory 230 may store various pieces of data used by at least one component (e.g., the processor 220 or the sensor module 276) of the electronic device 201. The various pieces of data may include, for example, software (e.g., the program 240) and input data or output data for a command related thereto. The memory 230 may include the volatile memory 232 or the non-volatile memory 234.

The program 240 may be stored as software in the memory 230, and may include, for example, an operating system (OS) 242, middleware 244, or an application 246.

The input module 250 may receive a command or data to be used by another component (e.g., the processor 220) of the electronic device 201, from the outside (e.g., a user) of the electronic device 201. The input module 250 may include, for example, a microphone, a mouse, a keyboard, a key (e.g., a button), or a digital pen (e.g., a stylus pen).

The sound output module 255 may output a sound signal to the outside of the electronic device 201. The sound output module 255 may include, for example, a speaker or a receiver. The speaker may be used for general purposes, such as playing multimedia or playing record. The receiver may be used to receive an incoming call. According to an embodiment, the receiver may be implemented separately from the speaker or as a portion of the speaker.

The display module 260 may visually provide information to the outside (e.g., a user) of the electronic device 201. The display module 260 may include, for example, a display, a hologram device, or a projector and control circuitry to control a corresponding one of the display, hologram device, and projector. According to an embodiment, the display module 260 may include a touch sensor adapted to sense a touch, or a pressure sensor adapted to measure an intensity of a force incurred by the touch.

The audio module 270 may convert a sound into an electrical signal or vice versa. According to an embodiment, the audio module 270 may obtain the sound via the input module 250 or output the sound via the sound output module 255 or an external electronic device (e.g., the electronic device 202 such as a speaker or a headphone) directly or wirelessly connected to the electronic device 201.

The sensor module 276 may detect an operational state (e.g., power or temperature) of the electronic device 201 or an environmental state (e.g., a state of a user) external to the electronic device 201, and generate an electrical signal or data value corresponding to the detected state. According to an embodiment, the sensor module 276 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 277 may support one or more specified protocols to be used for the electronic device 201 to be coupled with the external electronic device (e.g., the electronic device 202) directly (e.g., by wire) or wirelessly. According to an embodiment, the interface 277 may include, for example, a high-definition multimedia interface (HDMI), a universal serial bus (USB) interface, a secure digital (SD) card interface, or an audio interface.

The connecting terminal 278 may include a connector via which the electronic device 201 may be physically connected, directly or indirectly, to an external electronic device (e.g., the electronic device 202). According to an embodiment, the connecting terminal 278 may include, for example, an HDMI connector, a USB connector, an SD card connector, or an audio connector (e.g., a headphone connector).

The haptic module 279 may convert an electrical signal into a mechanical stimulus (e.g., a vibration or a movement) or an electrical stimulus which may be recognized by a user via his or her tactile sensation or kinesthetic sensation. According to an embodiment, the haptic module 279 may include, for example, a motor, a piezoelectric element, or an electric stimulator.

The camera module 280 may capture a still image and a video. According to an embodiment, the camera module 280 may include one or more lenses, image sensors, ISPs, or flashes.

The power management module 288 may manage power supplied to the electronic device 201. According to an embodiment, the power management module 288 may be implemented as, for example, at least a portion of a power management integrated circuit (PMIC).

The battery 289 may supply power to at least one component of the electronic device 201. According to an embodiment, the battery 289 may include, for example, a primary cell which is not rechargeable, a secondary cell which is rechargeable, or a fuel cell.

The communication module 290 may support establishing a direct (e.g., wired) communication channel or a wireless communication channel between the electronic device 201 and the external electronic device (e.g., the electronic device 202, the electronic device 204, or the server 208) and performing communication via the established communication channel. The communication module 290 may include one or more communication processors that operate independently of the processor 220 (e.g., an application processor) and support direct (e.g., wired) communication or wireless communication. According to an embodiment, the communication module 290 may include a wireless communication module 292 (e.g., a cellular communication module, a short-range wireless communication module, or a global navigation satellite system (GNSS) communication module) or a wired communication module 294 (e.g., a local area network (LAN) communication module, or a power line communication (PLC) module). A corresponding one of these communication modules may communicate with the external electronic device 204 via the first network 298 (e.g., a short-range communication network, such as Bluetooth™, wireless-fidelity (Wi-Fi) direct, or infrared data association (IrDA)) or the second network 299 (e.g., a long-range communication network, such as a legacy cellular network, a 5G network, a next-generation communication network, the Internet, or a computer network (e.g., a LAN or a wide area network (WAN))). These various types of communication modules may be implemented as a single component (e.g., a single chip), or may be implemented as multi components (e.g., multiple chips) separate from each other. The wireless communication module 292 may identify or authenticate the electronic device 201 in a communication network, such as the first network 298 or the second network 299, using subscriber information (e.g., international mobile subscriber identity (IMSI)) stored in the SIM 296.

The wireless communication module 292 may support a 5G network after a 4G network, and a next-generation communication technology, e.g., a new radio (NR) access technology. The NR access technology may support enhanced mobile broadband (eMBB), massive machine type communications (mMTC), or ultra-reliable and low-latency communications (URLLC). The wireless communication module 292 may support a high-frequency band (e.g., a mmWave band) to achieve, e.g., a high data transmission rate. The wireless communication module 292 may support various technologies for securing performance on a high-frequency band, such as, e.g., beamforming, massive multiple-input and multiple-output (massive MIMO), full dimensional MIMO (FD-MIMO), an array antenna, analog beamforming, or a large scale antenna. The wireless communication module 292 may support various requirements specified in the electronic device 201, an external electronic device (e.g., the electronic device 204), or a network system (e.g., the second network 299). According to an embodiment, the wireless communication module 292 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 297 may transmit or receive a signal or power to or from the outside (e.g., an external electronic device) of the electronic device 201. According to an embodiment, the antenna module 297 may include an antenna including a radiating element including a conductive material or a conductive pattern formed in or on a substrate (e.g., a printed circuit board (PCB)). According to an embodiment, the antenna module 297 may include a plurality of antennas (e.g., array antennas). In such a case, at least one antenna appropriate for a communication scheme used in a communication network, such as the first network 298 or the second network 299, may be selected by, for example, the communication module 290 from the plurality of antennas. The signal or the power may be transmitted or received between the communication module 290 and the external electronic device via the at least one selected antenna. According to an embodiment, another component (e.g., a radio frequency integrated circuit (RFIC)) other than the radiating element may be additionally formed as a portion of the antenna module 297.

According to an embodiment, the antenna module 297 may form a mm Wave antenna module. For example, the mmWave antenna module may include a PCB, an RFIC disposed on a first surface (e.g., the bottom surface) of the PCB or adjacent to the first surface and capable of supporting a designated high-frequency band (e.g., the mmWave band), and a plurality of antennas (e.g., array antennas) disposed on a second surface (e.g., the top or a side surface) of the PCB, or adjacent to the second surface and capable of transmitting or receiving signals in the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 201 and the external electronic device 204 via the server 208 coupled with the second network 299. Each of the external electronic devices 202 and 204 may be a device of the same type as or a different type from the electronic device 201. According to an embodiment, all or some of operations to be executed at the electronic device 201 may be executed at one or more of external electronic devices (e.g., the external electronic devices 202 and 204, or the server 208). For example, if the electronic device 201 needs to perform a function or a service automatically, or in response to a request from a user or another device, the electronic device 201, instead of, or in addition to, executing the function or the service, may request one or more external electronic devices to perform at least a part of the function or the service. The one or more external electronic devices receiving the request may perform the at least part of the function or the service requested, or an additional function or an additional service related to the request, and transfer an outcome of the performing to the electronic device 201. The electronic device 201 may provide the outcome, with or without further processing of the outcome, as at least part of a reply to the request. To that end, a cloud computing, distributed computing, mobile edge computing (MEC), or client-server computing technology may be used, for example. The electronic device 201 may provide ultra low-latency services using, e.g., distributed computing or MEC. In another embodiment, the external electronic device 204 may include an Internet-of-things (IoT) device. The server 208 may be an intelligent server using machine learning and/or a neural network. According to an embodiment, the external electronic device 204 or the server 208 may be included in the second network 299. The electronic device 201 may be applied to intelligent services (e.g., a smart home, a smart city, a smart car, or healthcare) based on 5G communication technology or IoT-related technology.

The electronic device according to various embodiments may be one of various types of electronic devices. The electronic device may include, for example, a portable communication device (e.g., a smart phone), a computer device, a portable multimedia device, a portable medical device, a camera, a wearable device, or a home appliance device. According to an embodiment of the disclosure, the electronic device is not limited to those described above.

It should be appreciated that various embodiments of the present disclosure and the terms used therein are not intended to limit the technological features set forth herein to particular embodiments and include various changes, equivalents, or replacements for a corresponding embodiment. In connection with the description of the drawings, like reference numerals may be used for similar or related components. It is to be understood that a singular form of a noun corresponding to an item may include one or more of the things, unless the relevant context clearly indicates otherwise. As used herein, “A or B”, “at least one of A and B”, “at least one of A or B”, “A, B or C”, “at least one of A, B and C”, and “at least one of A, B, or C,” may include any one of the items listed together in the corresponding one of the phrases, or all possible combinations thereof. Terms such as “1^{st}”, “2^{nd}”, or “first” or “second” may simply be used to distinguish the component from other components in question, and do not limit the components in other aspects (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., by wire), wirelessly, or via at least a third element(s).

As used in connection with embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 240) including one or more instructions that are stored in a storage medium (e.g., an internal memory 236 or an external memory 238) that is readable by a machine (e.g., the electronic device 201). For example, a processor (e.g., the processor 220) of the machine (e.g., the electronic device 201) may invoke at least one of the one or more instructions stored in the storage medium, and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read-only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities, and some of the multiple entities may be separately disposed in different components. According to various embodiments, one or more of the above-described components or operations may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to an embodiment, operations performed by the module, the program, or another component may be carried out sequentially, in parallel, repeatedly, or heuristically, or one or more of the operations may be executed in a different order or omitted, or one or more other operations may be added.

FIGS. 3A to 3D are diagrams illustrating a wearable device according to an embodiment.

Referring to FIGS. 3A to 3D, a wearable device 300 (e.g., the wearable device 120 of FIG. 1) may be worn by a user to assist a gait of the user. For example, the wearable device 300 may be a device for assisting a gait of a user. Further, the wearable device 300 may be a workout device that provides a workout function by assisting a gait of the user and providing the user with a resistance force. For example, the resistance force provided to the user may be a force actively applied to the user, such as a force output by a device such as a motor. Alternatively, the resistance force may not be a force actively applied to the user, but may be a force that impedes a motion of the user, such as a frictional force. The resistance force may also be referred to as a workout load.

Although FIGS. 3A to 3D illustrate a hip-type wearable device 300, the type of the wearable device is not limited thereto. The wearable device may be a type that supports the entire lower limbs or a type that supports a portion of the lower limbs. In addition, the wearable device may be one of a type that supports a portion of the lower limbs, a type that supports up to the knees, a type that supports up to the ankles, and a type that supports the entire body.

The embodiments described with reference to FIGS. 3A to 3D may apply to a hip-type wearable device, but are not limited thereto, and may all apply to various types of wearable devices.

According to an embodiment, the wearable device 300 may include a driver 310, a sensor unit 320, an inertial measurement unit (IMU) 330, a controller 340, a battery 350, and a communication module 152. For example, the IMU 330 and the controller 340 may be disposed in a main frame of the wearable device 300. For example, the IMU 330 and the controller 340 may be included in a housing that is formed in (or attached to) the outside of the main frame of the wearable device 300.

The driver 310 may include a motor 314 and a motor driver circuit 312 for driving the motor 314. The sensor unit 320 may include at least one sensor 321. The controller 340 may include a processor 342, a memory 344, and an input interface 346. Although the wearable device 300 is illustrated in FIG. 3C as including one sensor 321, one motor driver circuit 312, and one motor 314, this may be provided merely as an example, and a wearable device 300-1 may include a plurality of sensors 321 and 321-1, a plurality of motor driver circuits 312 and 312-1, and a plurality of motors 314 and 314-1 according to another example as illustrated in FIG. 3D. Also, according to implementation, the wearable device 300 may include a plurality of processors. The number of motor driver circuits, the number of motors, or the number of processors may vary depending on a body part on which the wearable device 300 is worn.

The following description of the sensor 321, the motor driver circuit 312, and the motor 314 may also apply to the sensor 321-1, the motor driver circuit 312-1, and the motor 314-1 illustrated in FIG. 3D.

The driver 310 may drive a hip joint of a user. For example, the driver 310 may be positioned on the right hip portion and/or the left hip portion of the user. The driver 310 may be additionally positioned on the knee portions and the ankle portions of the user. The driver 310 may include the motor 314 for generating a rotational torque and the motor driver circuit 312 for driving the motor 314.

The sensor unit 320 may measure the angles of the hip joints of the user during a gait. Information on the angles of the hip joints sensed by the sensor unit 320 may include the angle of the right hip joint, the angle of the left hip joint, the difference between the angles of both hip joints, and the hip joint motion direction. For example, the sensor 321 may be positioned in the driver 310. According to the position of the sensor 321, the sensor unit 320 may additionally measure the angles of the knees and the angles of the ankles of the user. The sensor 321 may be an encoder. The information on the angles of the joints measured by the sensor unit 320 may be transmitted to the controller 340.

According to an embodiment, the sensor unit 320 may include a potentiometer. The potentiometer may sense an R-axis joint angle, an L-axis joint angle, an R-axis joint angular velocity, and an L-axis joint angular velocity according to a gait motion of the user. In this example, the R and L axes may be reference axes for the right leg and the left leg of the user, respectively. For example, the R and L axes may be set to be vertical to the ground and set such that a front side of a body of a person has a negative value and a rear side of the body has a positive value.

The IMU 330 may measure acceleration information and pose information during a gait. For example, the IMU 330 may sense X-axis, Y-axis, and Z-axis accelerations and X-axis, Y-axis, and Z-axis angular velocities according to the gait motion of the user. The acceleration information and pose information measured by the IMU 330 may be transmitted to the controller 340.

In addition to the sensor unit 320 and the IMU 330 described above, the wearable device 300 may include a sensor (e.g., an electromyogram (EMG) sensor) configured to sense a change in a quantity of motion of the user or a change in a biosignal according to a gait motion.

The controller 340 may control an overall operation of the wearable device 300. For example, the controller 340 may receive the information sensed by each of the sensor unit 320 and the IMU 330. The information sensed by the IMU 330 may include acceleration information and pose information, and the information sensed by the sensor unit 320 may include the angle of the right hip joint, the angle of the left hip joint, the difference between the angles of the two hip joints, and the hip joint motion direction. According to an embodiment, the controller 340 may calculate the difference between the angles of both hip joints based on the angle of the right hip joint and the angle of the left hip joint. The controller 340 may generate a signal for controlling the driver 310 based on the sensed information. For example, the generated signal may be an assistance force for assisting a gait of the user. Alternatively, the generated signal may be a resistance force for impeding a gait of the user. The resistance force may be provided to the user to assist the user in doing a workout. In the following description, a negative magnitude of a workout load (or a torque) may indicate a resistance force, and a positive magnitude thereof may indicate an assistance force.

According to an embodiment, the processor 342 of the controller 340 may control the driver 310 to provide the user with a resistance force. For example, the driver 310 may provide the user with a resistance force by applying an active force to the user through the motor 314. Alternatively, the driver 310 may provide the user with a resistance force using the back-drivability of the motor 314, without applying an active force to the user. The back-drivability of the motor may be a responsiveness of the rotation axis of the motor to an external force. When the back-drivability of the motor increases, the motor may more readily respond to an external force acting on the rotation axis of the motor (that is, the rotation axis of the motor may more readily rotate). Even when the same external force is applied to the rotation axis of the motor, the degree of rotation of the rotation axis of the motor may vary depending on the degree of back-drivability.

According to an embodiment, the processor 342 of the controller 340 may control the driver 310 such that the driver 310 may output a torque (or an assistance torque) for assisting a gait of the user. For example, in the hip-type wearable device 300, the driver 310 may be disposed on each of the left hip portion and the right hip portion, and the controller 340 may output a control signal for controlling the driver 310 to generate a torque.

The driver 310 may generate a torque based on the control signal output by the controller 340. A torque value for generating the torque may be externally set or be set by the controller 340. For example, to indicate a magnitude of the torque value, the controller 340 may use a magnitude of a current for the signal transmitted to the driver 310. That is, as the magnitude of the current received by the driver 310 increases, the torque value may increase. As another example, the processor 342 of the controller 340 may transmit the control signal to the motor driver circuit 312 of the driver 310, and the motor driver circuit 312 may generate a current corresponding to the control signal to control the motor 314.

The battery 350 may supply power to the components of the wearable device 300. The wearable device 300 may further include a circuit (e.g., a PMIC) configured to convert the power of the battery 350 according to an operating voltage of the components of the wearable device 300 and provide the same to the components of the wearable device 300. In addition, the battery 350 may or may not supply power to the motor 314 based on an operation mode of the wearable device 300.

The communication module 352 may support the establishment of a direct (or wired) communication channel or a wireless communication channel between the wearable device 300 and an external electronic device, and support the communication through the established communication channel. The communication module 352 may include one or more communication processors configured to support direct (or wired) communication or wireless communication. According to an embodiment, the communication module 352 may include a wireless communication module (e.g., a cellular communication module, a short-range wireless communication module, or a GNSS communication module) or a wired communication module (e.g., a LAN communication module or a PLC module). A corresponding one of these communication modules may communicate with the external electronic device via a first network (e.g., a short-range communication network such as Bluetooth™, Wi-Fi direct, or IrDA) or a second network (e.g., a legacy cellular network, a 5G network, a next-generation communication network, the Internet, or a computer network). These various types of communication modules may be implemented as a single component (e.g., a single chip), or may be implemented as multi components (e.g., multiple chips) separate from each other.

According to an embodiment, the electronic device 201 described above with reference to FIG. 2 may be included in the wearable device 300.

According to an embodiment, the electronic device 201 described above with reference to FIG. 2 may be a separate device physically separated from the wearable device 300, and the electronic device 201 and the wearable device 300 may be connected through short-range wireless communication.

FIG. 4 is a diagram illustrating a wearable device communicating with an electronic device according to an embodiment.

Referring to FIG. 4, the wearable device 300 (e.g., the wearable device 120 of FIG. 1) described above with reference to FIGS. 3A to 3D may communicate with the electronic device 201 (e.g., the electronic device 110 of FIG. 1) described above with reference to FIG. 2. For example, the electronic device 201 may be an electronic device of a user of the wearable device 300. According to an embodiment, the wearable device 300 and the electronic device 201 may be connected using a short-range wireless communication method.

The electronic device 201 may display a user interface (UI) for controlling an operation of the wearable device 300 on a display 201-1. The UI may include, for example, at least one soft key through which the user may control the wearable device 300.

The user may input a command for controlling the operation of the wearable device 300 through the UI on the display 201-1 of the electronic device 201, and the electronic device 201 may generate a control instruction corresponding to the command and transmit the generated control instruction to the wearable device 300. The wearable device 300 may operate according to the received control instruction, and transmit a control result to the electronic device 201. The electronic device 201 may display a control completion message on the display 201-1 of the electronic device 201.

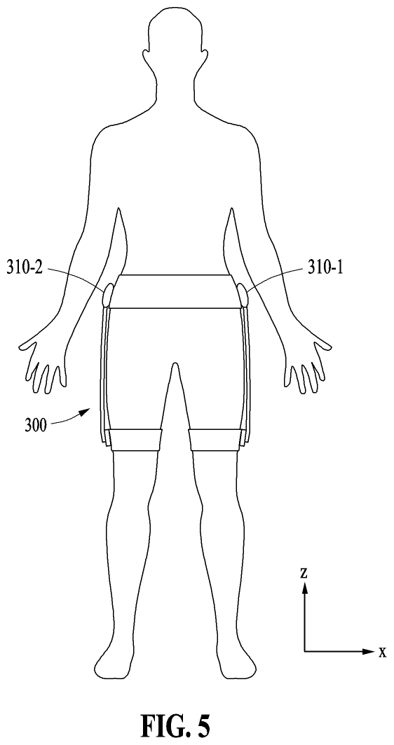

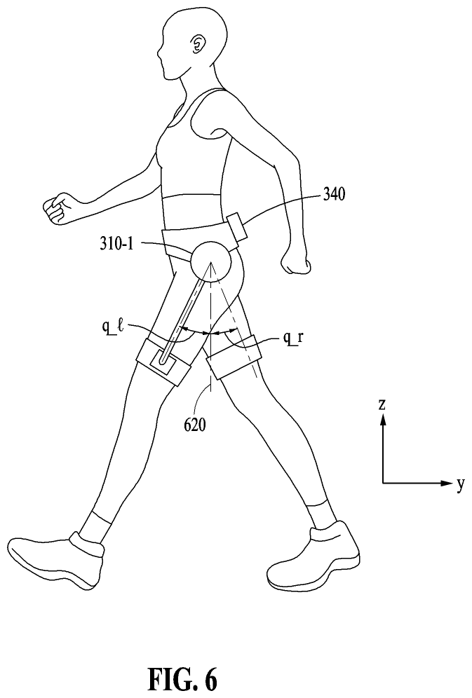

FIGS. 5 and 6 are diagrams illustrating a torque output method of a wearable device according to an embodiment.

Referring to FIGS. 5 and 6, drivers 310-1 and 310-2 of the wearable device 300 of FIG. 3 (e.g., the wearable device 120 of FIG. 1) may be disposed near the hip joints of a user, and the controller 340 of the wearable device 300 may be disposed near the lower back of the user. The positions of the drivers 310-1 and 310-2 and the controller 340 are not limited to the example positions illustrated in FIGS. 5 and 6.

The wearable device 300 may measure (or sense) a left hip joint angle q_l and a right hip joint angle q_r of the user. For example, the wearable device 300 may measure the left hip joint angle q_l of the user through a left encoder and measure the right hip joint angle q_r of the user through a right encoder. As illustrated in FIG. 6, the left hip joint angle q_l may be negative because the left leg of the user is in front of a reference line 620, and the right hip joint angle q_r may be positive because the right leg of the user is behind the reference line 620. According to an implementation example, the right hip joint angle q_r may be negative when the right leg is in front of the reference line 620, and the left hip joint angle q_l may be positive when the left leg is behind the reference line 620.

According to an embodiment, the wearable device 300 may obtain a first angle (e.g., q_r) and a second angle (e.g., q_l) by filtering a first raw angle (e.g., q_r_raw) of a first joint (e.g., the right hip joint) and a second raw angle (e.g., q_l_raw) of a second joint (e.g., the left hip joint) measured by the sensor unit 320. For example, the wearable device 300 may filter the first raw angle and the second raw angle based on a first previous angle and a second previous angle measured with respect to a previous time.

According to an embodiment, the wearable device 300 may determine a torque value τ(t) based on the left hip joint angle q_l, the right hip joint angle q_r, an offset angle c, a sensitivity α, a gain κ, and a delay Δt, and control the motor driver circuit 312 of the wearable device 300 to output the determined torque value τ(t). The force provided to the user by the torque value τ(t) may be referred to herein as force feedback. For example, the wearable device 300 may determine the torque value τ(t) based on Equation 1 below.

$$y = sin ( q\_r ) - sin ( q\_l ) \\ τ ( t ) = κ y ( t - Δ t ) \qquad [ Equation 1 ]$$

In Equation 1, y denotes a state factor, q_r denotes the right hip joint angle, and q_l denotes the left hip joint angle. According to Equation 1, the state factor y may be associated with the distance between the two legs. For example, y being “0” may indicate a state (e.g., a crossing state) in which the distance between the legs is “0”, and the absolute value of y being maximum may indicate a state (e.g., a landing state) in which the angle between the legs is maximum. According to an embodiment, when q_r and q_l are measured at a time t, the state factor may be represented as y(t).

The gain κ is a parameter indicating the magnitude and direction of an output torque. As the magnitude of the gain κ increases, a greater torque may be output. If the gain κ is negative, a torque acting as a resistance force may be output to the user, and if the gain κ is positive, a torque acting as an assistance force may be output to the user. The delay Δt is a parameter associated with a torque output timing. The value of the gain κ and the value of the delay Δt may be preset, and may be adjustable by a user, the wearable device 300, or the electronic device 201 described above with reference to FIG. 2.

A model for outputting a torque acting as an assistance force to a user using Equation 1 may be a torque output model (or a torque output algorithm). The wearable device 300 or the electronic device 201 may determine the magnitude and delay of a torque to be output by inputting the values of input parameters received through sensors into the torque output model.

According to an embodiment, the wearable device 300 or the electronic device 201 may determine a first torque value through Equation 2 below by applying a first gain value and a first delay value to a first state factor y(t), wherein the first gain value and the first delay value may be parameter values determined with respect to the state factor y(t).

$${τ}_{l} ( t ) = κ y ( t - Δ t ) \\ {τ}_{r} ( t ) = - κ y ( t - Δ t ) \qquad [ Equation 2 ]$$

The calculated first torque value may include a value for the first joint and a value for the second joint since it should be applied to the two legs. For example, τl(t) may be a value for the left hip joint, which is the second joint, and τr(t) may be a value for the right hip joint, which is the first joint. τl(t) and τr(t) may be values with the same magnitude and opposite torque directions. The wearable device 300 may control the motor driver circuit 312 of the wearable device 300 to output a torque corresponding to the first torque value.

According to an embodiment, when the user performs an asymmetrical gait with the left leg and the right leg, the wearable device 300 may provide asymmetrical torques respectively to both legs of the user to assist the asymmetric gait. For example, a stronger assistance force may be provided to a leg with a shorter stride width or a slower swing speed. Hereinafter, a leg with a small stride width or a slow swing speed will be referred to as an affected leg or a target leg.

In general, an affected leg may have a shorter swing time or a smaller stride width than an unaffected leg. According to an embodiment, a method of adjusting the timing of a torque acting on an affected leg to assist a gait of a user may be considered. For example, an offset angle may be added to an actual joint angle of an affected leg to increase an output time of a torque for assisting a swing motion of the affected leg. c may be the value of a parameter indicating an offset angle between joint angles. As the offset angle is added to the actual joint angle of the affected leg, the value of an input parameter that is input into the torque output model mounted on (or applied to) the wearable device 300 may be adjusted. For example, the values of q_r and q_l may be adjusted through Equation 3 below. cᵣ denotes an offset angle with respect to the right hip joint, and cl denotes an offset angle with respect to the left hip joint.

$${q}_{\_ r} ( t ) ← {q}_{\_ r} ( t ) + {c}_{r} \\ {q}_{\_ l} ( t ) ← {q}_{\_ l} ( t ) + {c}_{l} \qquad [ Equation 3 ]$$

According to an embodiment, the wearable device 300 may filter the state factor to reduce the discomfort the user may experience due to irregular torque outputs. For example, the wearable device 300 or the electronic device 201 may determine an initial state factor y_{raw}(t) of a current time t based on the first angle of the first joint and the second angle of the second joint, and determine the first state factor y(t) based on a previous state factor y^{prv} determined with respect to a previous time t−1 and the initial state factor y_{raw}(t). The current time t may be a time at which t-th data (or sample) is processed, and the previous time t−1 may be a time at which t−1-th data is processed. For example, the difference between the current time t and the previous time t−1 may be an operation interval of a processor for generating or processing the corresponding items of data. The sensitivity α may be the value of a parameter indicating a sensitivity. For example, the sensitivity value may be continuously adjusted during a test gait. However, the sensitivity value may be preset to a predetermined value to reduce the computational complexity.

FIG. 7 illustrates areas of workout intensity according to user's ages and workout purposes according to an embodiment.

According to an embodiment, the workout purpose may include strength training, aerobic exercise, fat-burning exercise, and warm-up. For example, the strength training may require a person's current heart rate to be in a first section 710, where 80% to 90% of a maximum heart rate is maintained. For example, the aerobic exercise may require the person's current heart rate to be in a second section 720, where 70% to 80% of the maximum heart rate is maintained. For example, the fat-burning exercise may require the person's current heart rate to be in a third section 730, where 60% to 70% of the maximum heart rate is maintained. For example, the warm-up may require the person's current heart rate to be in a fourth section 740, where 50% to 60% of the maximum heart rate is maintained.

According to an embodiment, the maximum heart rate of a person may be predicted based on the person's age. The illustrated sections 710 to 740 are based on general demographic statistics, and the appropriate workout sections for a particular individual may vary depending on the individual's physical ability and disease. For example, a heart rate medically guided according to symptoms, age, and exercise capacity of people with cardiovascular disease is set as a safe limit, and the people may be recommended to reset before reaching the safe limit.

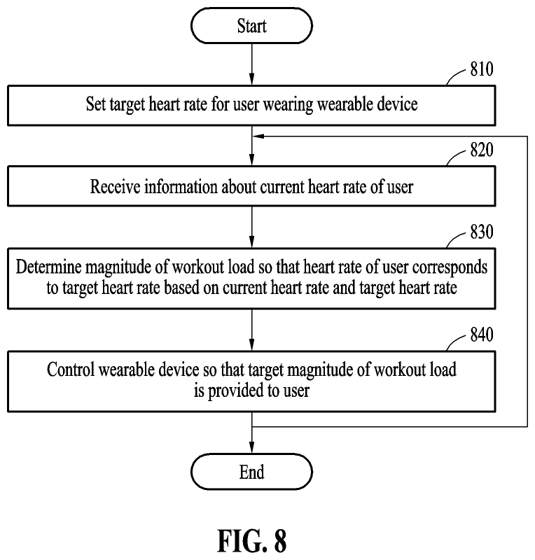

According to an embodiment, a maximum heart rate of a user using a wearable device (e.g., the wearable device 120 of FIG. 1 or the wearable device 300 of FIG. 3) may be determined, and a workout load appropriate for the workout purpose may be provided to the user through the wearable device based on the determined maximum heart rate and a current heart rate of the user who is doing a workout. A method of controlling the wearable device based on the heart rate of the user will be described in detail below with reference to FIGS. 8 to 13.

FIG. 8 is a flowchart illustrating a method of controlling a wearable device based on a heart rate of a user according to an embodiment.

Operations 810 and 840 may be performed by an electronic device (e.g., the electronic device 110 or the wearable device 120 of FIG. 1, the electronic device 201 of FIG. 2, or the wearable device 300 of FIG. 3).

In operation 810, the electronic device may set a target heart rate for a user wearing a wearable device (e.g., the wearable device 120 of FIG. 1 or the wearable device 300 of FIG. 3). The target heart rate may be set as a range with a lower limit heart rate and an upper limit heart rate.

For example, the target heart rate may be set based on a maximum heart rate of the user. For example, the target heart rate may be set based on the workout purpose of the user.

According to an embodiment, the maximum heart rate of the user may be predetermined based on at least one of physical information including the user's age, disease information, or a workout history. For example, the electronic device may receive information about the maximum heart rate from the user. For example, the electronic device may receive at least one of the physical information or the disease information from the user, and determine the maximum heart rate based on the received information and demographic statistics. For example, the electronic device may determine the maximum heart rate based on a maximum heart rate history stored in association with the workout history of the user.

According to an embodiment, the wearable device may generate at least one of the body composition information or electrocardiogram information of the user by using an electromyography sensor. The electronic device may determine the maximum heart rate of the user based on at least one of the body composition information or the electrocardiogram information received from the wearable device.

According to an embodiment, the electronic device may determine the target heart rate based on the workout purpose and the maximum heart rate set on the electronic device. For example, workout purpose may include strength training, aerobic exercise, fat-burning exercise, and warm-up. For example, the workout purpose set on the electronic device may be received from the user.

According to an embodiment, the electronic device may receive information about a workout environment from the user. For example, the workout environment may include a target workout section and a target workout time. The target workout section may be a workout path on which the user wants to do a workout. The electronic device or a server that receives the information about the workout environment from the electronic device (e.g., the server 140 of FIG. 1) may recommend a workout program to the user based on the workout environment. When the user selects the recommended workout program, the electronic device may determine the target heart rate based on the workout purpose of the workout program. For example, a total workout time of the workout program may be divided into one or more time sections (e.g., workout sessions), and different workout purposes may be respectively set in the time sections. For example, the workout program may be interval training that consists of or includes repeatedly alternating between sections with high and low target heart rates. For example, the workout program may be a program for improving a stride length, gait speed, or walking pose that may control a difference in target heart rates between sections to be small or great.

In operation 820, the electronic device may receive information about a current heart rate of the user. Operation 820 may be performed while the user is wearing a wearable device and doing a workout.

According to an embodiment, the electronic device may receive information about the current heart rate from an additional device (e.g., the additional device 130 of FIG. 1) worn by the user. For example, the information about the current heart rate of the user may be received from a smart watch (e.g., the smart watch 132 of FIG. 1) as the additional device.

According to an embodiment, the electronic device may receive the information about the current heart rate from the wearable device. For example, the wearable device may include a current sensor capable of sensing a current flowing through the skin in close contact with the user's skin. The current sensor may generate information about the current heart rate of the user.

According to an embodiment, the electronic device may receive information about the breathing of the user from the wearable device. For example, the wearable device may include a pressure sensor or a tensile force sensor capable of sensing the breathing of the user. When the user is breathing, the pressure sensor or the tensile force sensor located on a belt unit of the wearable device may generate the information about the breathing of the user. The electronic device may filter a noise of a value of the tensile force sensor, and calculate the number of breaths per minute based on the value from which the noise is filtered. The electronic device may determine the current heart rate using a correlation between the breaths per minute and the heart rate.

In operation 830, the electronic device may determine a target magnitude of a workout load output by the wearable device so that a heart rate of the user corresponds to the target heart rate based on the current heart rate and the target heart rate. For example, when the current heart rate exceeds the tar heart rate, the target magnitude may be determined to be less than a current magnitude of the workout load. For example, when the current heart rate is less than the target heart rate, the target magnitude may be determined to be greater than the current magnitude. For example, when the current heart rate corresponds to the target heart rate, the target magnitude may be determined to be equal to the current magnitude of the workout load. The electronic device may reduce the magnitude of the workout load by increasing a magnitude of an assistance force or reducing a magnitude of a resistance force. The electronic device may increase the magnitude of the workout load by reducing the magnitude of the assistance force or reducing the magnitude of the resistance force.

According to an embodiment, the electronic device may determine the target magnitude of the workout load based on a terrain change of a workout path of the user. For example, an altitude change of terrain, as the terrain change of the workout path, may be determined based on atmospheric pressure information generated by an atmospheric pressure sensor included in the wearable device or the additional device. For example, the electronic device may generate a graph of the altitude change in consideration of an error of the altitude change occurring according to a body motion of the user, and calculate at least one of a degree of slope of the terrain and a change rate of the degree of slope based on the graph of the altitude change. The electronic device may determine the target magnitude of the workout load based on the degree of slop of terrain and the change rate of the degree of slope.

According to an embodiment, although the current heart rate is within the section with the target heart rate, if the change of the degree of slop of terrain appears, the electronic device may determine the target magnitude of the workout load so that the current heart rate is not deviated from the section with the target heart rate due to a natural change of the magnitude of the workout load due to the change of the degree of slope of terrain. For example, when the degree of slope increases, the magnitude of the assistance force may increase or the magnitude of the resistance force may decrease. For example, when the degree of slope decreases, the magnitude of the assistance force may decrease or the magnitude of the resistance force may increase.

According to an embodiment, when the current heart rate is not in the section with the target current heart rate and the change of the degree of slop of terrain does not appear, the electronic device may determine the target magnitude of the workout load so that the current heart rate is within the target heart rate by the natural change of the magnitude of the workout load due to the change of the degree of slope of terrain and the magnitude of the workout load output by the wearable device. For example, when downhill appears in a case where the target magnitude of the workout load for increasing the current heart rate to be within the target heart rate based on flat ground is −4, the target magnitude of the workout load may be increased to −7 (that is, the resistance force may increase) to counteract the effect of the natural change of the magnitude of the workout load due to the downhill.

According to an embodiment, the target magnitude of the workout load may be determined based on the amount of change of the degree of slope. For example, an increase of the amount of change of the degree of slop to a positive side (+) may refer to an increase of the extent of increase of the degree of slope, and accordingly, the target magnitude of the workout load may be determined so that the assistance force gradually increases or the resistance force gradually decreases. For example, a decrease of the amount of change of the degree of slop to a negative side (−) may refer to a decrease of the extent of increase of the degree of slope, and accordingly, the target magnitude of the workout load may be determined so that the assistance force gradually increases or the resistance force gradually decreases.

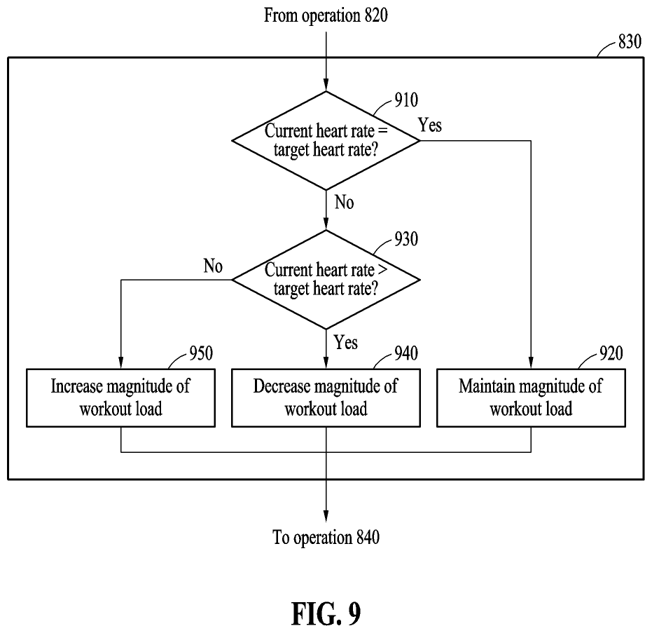

A method of determining the target magnitude of the workout load will be described in detail below with reference to FIGS. 9 to 11.

In operation 840, the electronic device may control the wearable device so that the target magnitude of the workout load is provided to the user. For example, the electronic device may transmit, to the wearable device, information about values of control parameters with which the target magnitude of the workout load may be output. For example, the wearable device may output the target magnitude of the workout load through a motor (e.g., the motor 314 of FIG. 3) based on the received values of the control parameters.

Operations 820 to 840 may be operations in a case where the current heart rate of the user is able to be measured directly or indirectly according to an embodiment.

According to an embodiment, when the current heart rate of the user is not able to be measured directly or indirectly, the electronic device may guide a workout speed appropriate to achieve the target heart rate to the user based on physical information of the user. The electronic device may determine the target magnitude of the workout load to achieve the target heart rate. For example, the electronic device may determine the natural change of the magnitude of the workout load according to the change of the degree of slope of terrain determined based on information obtained from the atmospheric pressure sensor, and determine the target magnitude of the workout load to be output by the wearable device.

According to an embodiment, the electronic device may actively adjust the magnitude of the workout load to be output to the user through the wearable device in operation 840, but may provide, to the user, a guide for the user to adjust the magnitude of the workout load by himself or herself without performing operation 840. For example, when it is required to increase the current heart rate, the electronic device may guide the user to increase a walking speed of a movement workout or increase a repetition speed of in-place workout.

According to an embodiment, the electronic device may provide guide information to the user through a user interface device of the wearable device. For example, the electronic device may provide the guide information to the user through a speaker, a display, or a haptic device of the wearable device.

According to an embodiment, the guide information may be provided to the user as a torque pattern mapped to have a preset meaning is output by the wearable device. For example, when the user stops while walking, the electronic device may control the wearable device so that the preset torque pattern (e.g., a slight forward and backward movement of a left motor and a right motor) is output by a motor of the wearable device, to provide a guide indicating the user to resume the walking.

According to an embodiment, the electronic device may provide guide information to the user through an additional device (e.g., the additional device 130 of FIG. 1) connected, directly or indirectly, to the electronic device. For example, when the additional device is wireless earphones (e.g., the wireless earphones 131 of FIG. 1), the guide information may be provided to the user through the wireless earphones. For example, when the additional device is a smart watch (e.g., the smart watch 132 of FIG. 1) or smart glasses (e.g., the smart glasses 133 of FIG. 1), visual, auditory, or tactile guide information may be provided to the user through the smart watch or the smart glasses.

According to an embodiment, the user may determine a current state of a workout through the guide information, and change a method of performing the workout based on the determined current state of the workout. For example, when the guide information indicates a low motion repetition speed of the in-place workout, the user may increase the motion repetition speed.

FIG. 9 is a flowchart of a method of determining a target magnitude of a workout load based on a current heart rate and a target heart rate according to an embodiment.

According to an embodiment, operation 830 described above with reference to FIG. 8 may include operations 910 to 950 to be described hereinafter. Operations 910 to 950 may be performed by an electronic device (e.g., the electronic device 110 or the wearable device 120 of FIG. 1, the electronic device of 201 of FIG. 2, or the wearable device 300 of FIG. 3).

In operation 910, the electronic device may determine whether the current heart rate of the user corresponds to the target heart rate. For example, the target heart rate may be a range with a lower limit heart rate and an upper limit heart rate. When the current heart rate is within the range of the target heart rate, the electronic device may determine that the current heart rate corresponds to the target heart rate.

In operation 920, when the current heart rate corresponds to the target heart rate, the electronic device may determine the target magnitude to be equal to the current magnitude of the workout load.

According to an embodiment, when the change of terrain of the workout path of the user appears in a case where the current heart rate is determined to correspond to the target heart rate, the electronic device may determine the target magnitude of the workout load so that the current heart rate is not deviated from the section with the target heart rate due to the natural change of the magnitude of the workout load according to the change of the degree of slope of terrain. For example, when the degree of slope increases, the magnitude of the assistance force may increase or the magnitude of the resistance force may decrease. For example, when the degree of slope decreases, the magnitude of the assistance force may decrease or the magnitude of the resistance force may increase.

In operation 930, the electronic device may determine whether the current heart rate of the user exceeds the target heart rate. For example, the electronic device may determine whether the current heart rate exceeds the upper limit heart rate of the target heart rate.

In operation 940, when it is determined that the current heart rate exceeds the target heart rate, the electronic device may determine the target magnitude to be less than the current magnitude of the workout load.

In operation 950, when it is determined that the current heart rate is less than the target heart rate, the electronic device may determine the target magnitude to be greater than the current magnitude of the workout load.

According to an embodiment, in operation 940 or operation 950, when the current heart rate is not within the section with the target heart rate and the change of the degree of slop of terrain appears, the electronic device may determine the target magnitude of the workout load so that the current heart rate is within the target heart rate due to the natural change of the magnitude of the workout load due to the change of the degree of slope of terrain and the magnitude of the workout load output by the wearable device.

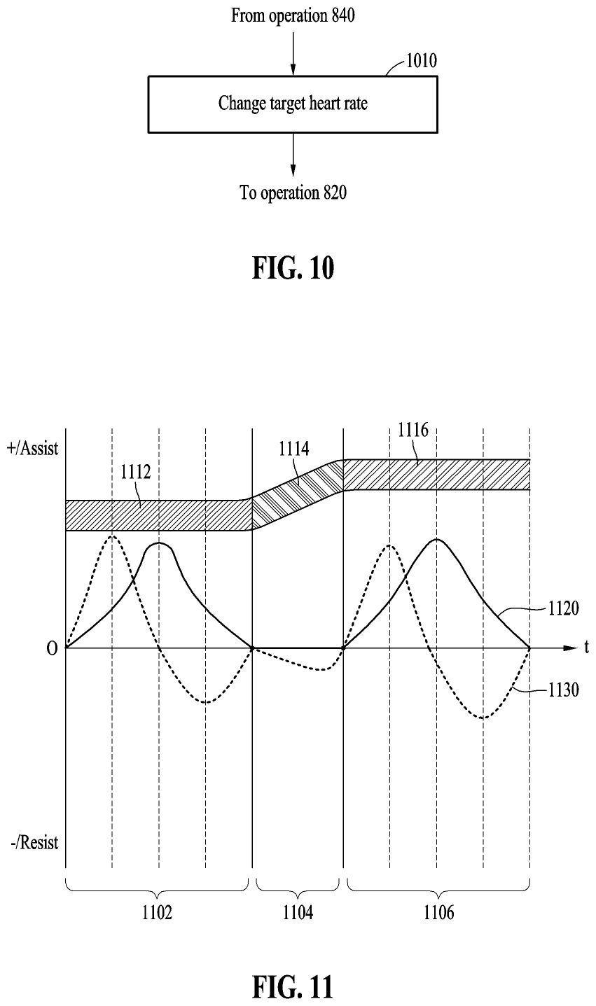

FIG. 10 is a flowchart illustrating a method of changing a target heart rate according to an embodiment.

According to an embodiment, operation 1010 may be further performed after operation 840 described above with reference to FIG. 8 is performed. Operation 1010 may be performed by an electronic device (e.g., the electronic device 110 or the wearable device 120 of FIG. 1, the electronic device 201 of FIG. 2, or the wearable device 300 of FIG. 3).

In operation 1010, the electronic device may change the target heart rate.

According to an embodiment, when the workout purpose of a workout session of a workout program is changed, the electronic device may change the target heart rate to correspond to the changed workout purpose. For example, when the workout session of the workout program is changed from a strength workout section to an aerobic workout section, the target heart rate may be changed from a first target heart rate for the strength workout section to a second target heart rate for the aerobic workout section. The first target heart rate for the strength workout section may be higher than the second target heart rate for the aerobic workout section.

According to an embodiment, when the time in which the current heart rate of the user is deviated from the section with the target heart rate continues for a predetermined section of time or longer, the electronic device may change the target heart rate.

For example, when the current heart rate is less than the target heart rate, it may be considered that the workout is not possible within the section with the original target heart rate due to accumulation of fatigue of the user. In the above case, the electronic device may lower the target heart rate. The electronic device may suggest the lowering of the target heart rate to the user, and when the user accepts the above suggestion, the target heart rate may be lowered.

For example, when the current heart rate exceeds the target heart rate, it may be considered that the user wants to do an intense workout. In the above case, the electronic device may increase the target heart rate. The electronic device may suggest the increasing of the target heart rate to the user, and when the user accepts the above suggestion, the target heart rate may be increased.

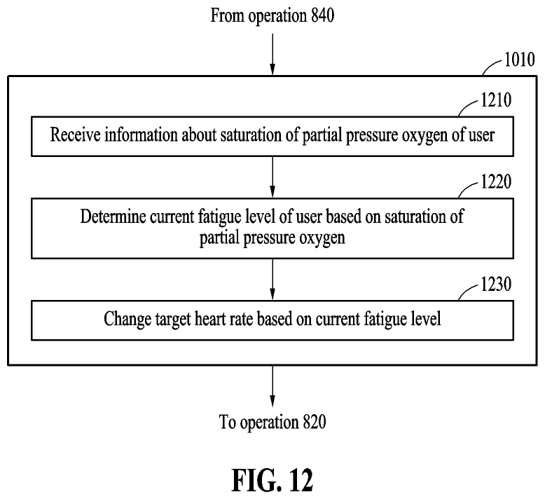

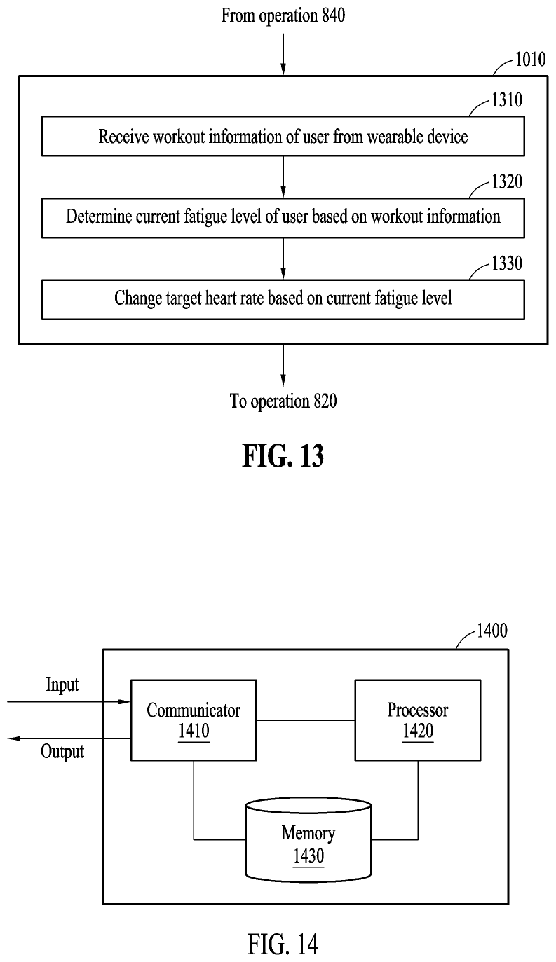

According to an embodiment, the electronic device may change the target heart rate based on a current fatigue level of the user. For example, when the time, during which the current heart rate of the user is deviated from the section with the target heart rate continues for a predetermined section of time or longer in a state where the current fatigue level is equal to or more than a preset threshold value, it may be considered that the workout is not possible within the section with the original target heart rate due to the accumulation of fatigue of the user. In the above case, the electronic device may lower the target heart rate. A method of changing the target heart rate based on the current fatigue level will be described in detail below with reference to FIGS. 12 and 13.

FIG. 11 illustrates a change in target heart rate, an altitude change, a magnitude change of a workout load to be output in a workout program including a plurality of workout sections according to an embodiment.

According to an embodiment, the workout program may include a plurality of workout sections 1102, 1104, and 1106. For example, the workout section 1102 may be a section for a fat-burning workout, the workout section 1106 may be a section for an aerobic workout, and the workout section 1104 may be a conversion section for a gradual transition between the workout section 1102 and the workout section 1106.

The target heart rate may be set to a first section 1112 during the workout of the user in the workout section 1102, the target heart rate may be set to a second section 1114 during the workout of the user in the workout section 1104, and the target heart rate may be set to a third section 1116 during the workout of the user in the workout section 1106.

When an altitude 1120 of a workout path of the user changes during the workout section 1102, a target magnitude 1130 of a workout load to achieve the first section 1112 may be changed based on the changing altitude 1120. For example, when the altitude 1120 increases, a magnitude of an assistance force increases due to a natural increase of the workout load. When the altitude 1120 decreases, the magnitude of the assistance force decreases or a resistance force may be provided to the user due to a natural decrease of the workout load.

The altitude 1120 of the workout path of the user does not change during the workout section 1114, however, since the second section 1114 gradually increases, the target magnitude 1130 of the workout load to achieve the second section 1114 may change. For example, the resistance force may be provided to the user to increase the magnitude of the workout load.

When the altitude 1120 of the workout path of the user changes during the workout section 1106, the target magnitude 1130 of the workout load to achieve the third section 1116 may be changed based on the changing altitude 1120. For example, when the altitude 1120 increases, the magnitude of the assistance force increases due to a natural increase of the workout load. When the altitude 1120 decreases, the magnitude of the assistance force decreases or the resistance force may be provided to the user due to a natural decrease of the workout load. Compared to the workout section 1104, the third section 1116 set in the exercise section 1106 is higher than the first section 1112, and therefore, the target magnitude 1130 of the workout load to be output to the user may be generally greater in the workout section 1106 than in the workout section 1102.

FIG. 12 is a flowchart illustrating a method of changing a target heart rate based on saturation of partial pressure oxygen of a user according to an embodiment.

According to an embodiment, operation 1010 described above with reference to FIG. 10 may include operations 1210 to 1230 to be described hereinafter. Operations 1210 to 1230 may be performed by an electronic device (e.g., the electronic device 110 or the wearable device 120 of FIG. 1, the electronic device 201 of FIG. 2, or the wearable device 300 of FIG. 3).

In operation 1210, the electronic device may receive information about saturation of partial pressure oxygen (SpO2) of a user.

According to an embodiment, the electronic device may receive information about a current heart rate from an additional device (e.g., the additional device 130 of FIG. 1) worn by the user. For example, the information about the saturation of partial pressure oxygen of the user may be received from a smart watch (e.g., the smart watch 132 of FIG. 1) as the additional device.

In operation 1220, the electronic device may determine a current fatigue level of the user based on the saturation of partial pressure oxygen. For example, a fatigue level corresponding to a value of the saturation of partial pressure oxygen may be determined as the current fatigue level of the user.

In operation 1230, the electronic device may change a target heart rate based on the current fatigue level. For example, the target heart rate may decrease based on the current fatigue level.

FIG. 13 is a flowchart illustrating a method of changing a target heart rate based on workout information of a user according to an embodiment.

According to an embodiment, operation 1010 described above with reference to FIG. 10 may include operations 1310 to 1330 to be described hereinafter. Operations 1310 to 1330 may be performed by an electronic device (e.g., the electronic device 110 or the wearable device 120 of FIG. 1, the electronic device 201 of FIG. 2, or the wearable device 300 of FIG. 3).

In operation 1310, the electronic device may receive workout information of a user from a wearable device. For example, the workout information may include sensing information.

For example, the sensing information may include an angle of a left hip joint and an angle of a right hip joint of the user generated by an encoder of the wearable device positioned at the joint. For example, the sensing information may include acceleration information and pose information generated by an IMU of the wearable device. For example, the sensing information may include biometric information generated by a biosensor. For example, the sensing information may include position information generated by a global positioning system (GPS) sensor. Each component in the sensing information may be associated with a timestamp.

In operation 1320, the electronic device may determine a current fatigue level of the user based on the workout information.

According to an embodiment, the electronic device may obtain a current value of an evaluation item for the workout based on the workout information. For example, the evaluation item for walking may be an indicator related to a walking speed (e.g., the number of steps per minute, a change in stride length, a change of a widening angle of a hip joint when stepping left and right, a change in time between steps, or a walking speed). For example, the evaluation item for walking may be an indicator related to an accuracy of a walking pose (e.g., a ratio of symmetry of time of left and right stepping, a ratio of symmetry of widening of the hip joint with the left and right stepping, a change rate of time of left and right stepping, a change rate of widening of the hip joint with the left and right stepping, an angle of pelvic tilt, a pelvic rotation angle, a deviation rate of pelvic trajectory, or a swing trajectory of the IMU). For example, the evaluation item for an in-place workout may be an indicator related to a motion repetition speed, a motion available range, muscle power obtained by measuring a motor torque generated according to the motion repetition speed, or an accuracy of a pose (e.g., an angle of pelvic tilt, a pelvic rotation angle, or a deviation rate of pelvic trajectory).

According to an embodiment, the electronic device may determine the current fatigue level of the user based on a current value of the evaluation item for the workout. For example, the current fatigue level of the user may be determined based on a degree of deviation of the current value of the evaluation item from preset threshold sections.

In operation 1330, the electronic device may change the target heart rate based on the current fatigue level. For example, the target heart rate may decrease based on the current fatigue level.

FIG. 14 is a diagram illustrating a configuration of a server according to an embodiment.

A server 1400 may include a communicator 1410 comprising communication circuitry, a processor 1420, and a memory 1430. For example, the server 1400 may be the server 140 described above with reference to FIG. 1.

The communicator 1410 may be connected, directly or indirectly, to the processor 1420 and the memory 1430 to transmit and receive data to and from the processor 1420 and the memory 1430. The communicator 1410 may be connected to another external device and may transmit and receive data to and from the external device.

The communicator 1410 may be implemented as circuitry in the server 1400. For example, the communicator 1410 may include an internal bus and an external bus. In another example, the communicator 1410 may be an element that connects the server 1400 and the external device. The communicator 1410 may be an interface. The communicator 1410 may receive data from the external device and transmit the data to the processor 1420 and the memory 1430.

The processor 1420 may process the data received by the communicator 1410 and data stored in the memory 1430. A “processor” may be a hardware-implemented data processing device having a physically structured circuit to execute desired operations. The desired operations may include, for example, code or instructions included in a program. The hardware-implemented data processing device may include, for example, a microprocessor, a CPU, a processor core, a multi-core processor, a multiprocessor, an ASIC, and a field-programmable gate array (FPGA).

The processor 1420 may execute computer-readable code (e.g., software) stored in a memory (e.g., the memory 1430) and instructions triggered by the processor 1420.

The memory 1430 may store the data received by the communicator 1410 and the data processed by the processor 1420. For example, the memory 1430 may store a program (or an application, or software). The program to be stored may be a set of syntaxes that is executable by the processor 1420 by being coded to determine recommended workout programs based on information about a user of a wearable device (e.g., the wearable device 120 of FIG. 1 or the wearable device 300 of FIG. 3) received from an electronic device (e.g., the electronic device 110 of FIG. 1 or the electronic device 201 of FIG. 2).

According to an embodiment, the memory 1430 may include at least one volatile memory, nonvolatile memory, random-access memory (RAM), flash memory, a hard disk drive, and an optical disc drive.

The memory 1430 may store an instruction set (e.g., software) for operating the server 1400. The instruction set for operating the server 1400 may be executed by the processor 1420. According to an embodiment, the memory 1430 may include a database including information on a plurality of workout programs. According to an embodiment, the memory 1430 may include a database that stores a history of workout programs performed by a plurality of users.

According to an embodiment, an electronic device may include a communication module, comprising communication circuitry, configured to exchange data with an external device, and at least one processor configured to control the electronic device. The at least one processor may be configured to set a target heart rate of a user wearing a wearable device, receive information about a current heart rate of the user, determine a target magnitude of a workout load so that a heart rate of the user corresponds to the target heart rate based on the current heart rate and the target heart rate, and control the wearable device so that the target magnitude of the workout load is provided to the user.

Each “processor” herein includes processing circuitry, and/or may include multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

According to an embodiment, the processor may be configured to set the target heart rate based on at least one of a workout history, physical information, or disease information of the user.

According to an embodiment, the processor may be configured to determine a maximum or high heart rate of the user, and set the target heart rate based on the maximum or high heart rate.

According to an embodiment, the processor may be configured to set the target heart rate based on a workout program set for the user.

According to an embodiment, the processor may be configured to receive information about the current heart rate from an additional device connected to the electronic device through the communication module.

According to an embodiment, the processor may be configured to, when the current heart rate exceeds the target heart rate, determine the target magnitude to be less than a current magnitude of the workout load.

According to an embodiment, the processor may be configured to, when the current heart rate is less than the target heart rate, determine the target magnitude to be greater than a current magnitude of the workout load.

According to an embodiment, the processor may be configured to determine the target magnitude of the workout load based on terrain information of a location of the electronic device or the wearable device.

According to an embodiment, the processor may be configured to change the target heart rate based on a workout program set for the user.

According to an embodiment, the workout program may include strength workout section and an aerobic workout section, and a first target heart rate of the strength workout section may be higher than a second target heart rate of the aerobic workout section.

According to an embodiment, the processor may be configured to receive information about saturation of partial pressure oxygen (SpO2) of the user, determine a current fatigue level of the user based on the saturation of partial pressure oxygen, and change the target heart rate based on the current fatigue level.

According to an embodiment, the processor may be configured to receive workout information of the user from the wearable device, determine a current fatigue level of the user based on the workout information, and change the target heart rate based on the current fatigue level.

According to an embodiment, the workout information may include at least one of a joint angle and a joint angular velocity of the wearable device.

According to an embodiment, the processor may be configured to output information about the target magnitude of the workout load to the user.

According to an embodiment, the electronic device may be physically separated from the wearable device, and the electronic device and the wearable device may be connected to a short-range wireless communication.

According to an embodiment, the electronic device may be included in the wearable device.

According to an embodiment, a method performed by the electronic device may include setting a target heart rate of a user wearing a wearable device, receiving information about a current heart rate of the user, determining a target magnitude of a workout load so that a heart rate of the user corresponds to the target heart rate based on the current heart rate and the target heart rate, and controlling the wearable device so that the target magnitude of the workout load is provided to the user.

According to an embodiment, a wearable device may include a processor configured to control the wearable device, at least one sensor configured to measure an angle of a joint of a user, a motor driver circuit configured to be controlled by the processor, a motor electrically connected, directly or indirectly, to the motor driver circuit, and a thigh support frame configured to transfer a torque generated by the motor to at least a portion of a leg of the user. The processor may be configured to set a target heart rate of the user wearing the wearable device, receive information about a current heart rate of the user, determine a target magnitude of a workout load so that a heart rate of the user corresponds to the target heart rate based on the current heart rate and the target heart rate, and control the motor driver circuit so that the target magnitude of the workout load is provided to the user.

According to an embodiment, the wearable device may further include a communication module configured to exchange data with an external device, and may receive information about the current heart rate from an additional device connected, directly or indirectly, to the wearable device through the communication module.

According to an embodiment, the wearable device may further include a sensor configured to measure the heart rate of the user, and may receive information about the current heart rate from the sensor.

The embodiments described herein may be implemented using a hardware component, a software component and/or a combination thereof. A processing device may be implemented using one or more general-purpose or special-purpose computers, such as, for example, a processor, a controller and an arithmetic logic unit (ALU), a DSP, a microcomputer, a FPGA, a programmable logic unit (PLU), a microprocessor or any other device capable of responding to and executing instructions in a defined manner. The processing device may run an OS and one or more software applications that run on the OS. The processing device also may access, store, manipulate, process, and generate data in response to execution of the software. For purpose of simplicity, the description of a processing device is used as singular; however, one skilled in the art will appreciate that a processing device may include multiple processing elements and/or multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software may also be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs and/or DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher-level code that may be executed by the computer using an interpreter.

The above-described devices may be configured to act as one or more software modules in order to perform the operations of the above-described examples, or vice versa.

As described above, although the embodiments have been described with reference to the limited drawings, a person skilled in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents.

Therefore, other implementations, other embodiments, and equivalents to the claims are also within the scope of the following claims.

While the disclosure has been illustrated and described with reference to various embodiments, it will be understood that the various embodiments are intended to be illustrative, not limiting. It will further be understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein

1. An electronic device comprising:
a communication module, comprising communication circuitry, configured to exchange data with an external device;
at least one processor, comprising communication circuitry; and
memory storing instructions that when executed by the at least one processor individually and/or collectively, cause the electronic device to at least:
set a target heart rate of a user of a wearable device;
receive information about a current heart rate of the user;
determine a target magnitude of a workout load so that a heart rate of the user corresponds to the target heart rate based on the current heart rate and the target heart rate; and
control the wearable device so that the target magnitude of the workout load is provided to the user.

2. The electronic device of claim 1, wherein when executed by the at least one processor individually and/or collectively, the instructions cause the electronic device to at least: set the target heart rate based on at least one of a workout history, physical information, or disease information of the user.

3. The electronic device of claim 1, wherein when executed by the at least one processor individually and/or collectively, the instructions cause the electronic device to at least:
determine a maximum and/or high heart rate of the user; and
set the target heart rate based on the maximum and/or high heart rate.

4. The electronic device of claim 1, wherein when executed by the at least one processor individually and/or collectively, the instructions cause the electronic device to at least: set the target heart rate based on a workout program set for the user.

5. The electronic device of claim 1, wherein when executed by the at least one processor individually and/or collectively, the instructions cause the electronic device to at least: receive information about the current heart rate from an additional device connected to the electronic device through the communication module.

6. The electronic device of claim 1, wherein when executed by the at least one processor individually and/or collectively, the instructions cause the electronic device to at least: when the current heart rate exceeds the target heart rate, determine the target magnitude to be less than a current magnitude of the workout load.

7. The electronic device of claim 1, wherein when executed by the at least one processor individually and/or collectively, the instructions cause the electronic device to at least: when the current heart rate is less than the target heart rate, determine the target magnitude to be greater than a current magnitude of the workout load.

8. The electronic device of claim 1, wherein when executed by the at least one processor individually and/or collectively, the instructions cause the electronic device to at least: determine the target magnitude of the workout load based on terrain information of a location of the electronic device or the wearable device.

9. The electronic device of claim 1, wherein when executed by the at least one processor individually and/or collectively, the instructions cause the electronic device to at least: change the target heart rate based on a workout program set for the user.

10. The electronic device of claim 9, wherein
the workout program comprises strength workout section and an aerobic workout section, and
a first target heart rate of the strength workout section is higher than a second target heart rate of the aerobic workout section.

11. The electronic device of claim 1, wherein when executed by the at least one processor individually and/or collectively, the instructions cause the electronic device to at least:
receive information about saturation of partial pressure oxygen (SpO2) of the user;
determine a current fatigue level of the user based on the saturation of partial pressure oxygen; and
change the target heart rate based on the current fatigue level.

12. The electronic device of claim 1, wherein when executed by the at least one processor individually and/or collectively, the instructions cause the electronic device to at least:
receive workout information of the user from the wearable device;
determine a current fatigue level of the user based on the workout information; and
change the target heart rate based on the current fatigue level.

13. The electronic device of claim 12, wherein the workout information comprise at least one of a joint angle and a joint angular velocity of the wearable device.

14. The electronic device of claim 1, wherein when executed by the at least one processor individually and/or collectively, the instructions cause the electronic device to at least: output information about the target magnitude of the workout load to the user.

15. The electronic device of claim 1, wherein
the electronic device is separated from the wearable device, and
the electronic device and the wearable device are connected to a short-range wireless communication.

16. The electronic device of claim 1, wherein the electronic device is included in the wearable device.

17. A method performed by an electronic device, the method comprising:
setting a target heart rate of a user wearing a wearable device;
receiving information about a current heart rate of the user;
determining a target magnitude of a workout load so that a heart rate of the user corresponds to the target heart rate based on the current heart rate and the target heart rate; and
controlling the wearable device so that the target magnitude of the workout load is provided to the user.

18. A wearable device comprising:
at least on processor, comprising communication circuitry;
at least one sensor configured to measure an angle of a joint of a user;
a motor driver circuit;
a motor electrically connected to the motor driver circuit;
a thigh support frame configured to transfer a torque generated by the motor to at least a portion of a leg of the user; and
memory storing instructions that when executed by the at least one processor individually and/or collectively, cause the electronic device to at least
set a target heart rate of the user of the wearable device;
receive information about a current heart rate of the user;
determine a target magnitude of a workout load so that a heart rate of the user corresponds to the target heart rate based on the current heart rate and the target heart rate; and
control the motor driver circuit so that the target magnitude of the workout load is provided to the user.

19. The wearable device of claim 18, further comprises a communication module configured to exchange data with an external device, and
wherein when executed by the at least one processor individually and/or collectively, the instructions cause the wearable device to at least: receive information about the current heart rate from an additional device connected, directly or indirectly, to the wearable device through the communication module.

20. The wearable device of claim 18, further comprises a sensor configured to measure the heart rate of the user, and
wherein when executed by the at least one processor individually and/or collectively, the instructions cause the wearable device to at least: receive information about the current heart rate from the sensor.
